(19) United States
(12) Patent Application Publication
(10) Pub. No.: US 2008/0035585 A1
(43) Pub. Date: Feb. 14, 2008

(54) Method and Apparatus for Recirculating Elutriation Fluids

(75) Inventor: Glen Delbert Antwiler, Lakewood, CO (US)

Correspondence Address: GAMBRO, INC;PATENT DEPARTMENT, 10810 W COLLINS AVE, LAKEWOOD, CO, 80215, US

(73) Assignee: GAMBRO BCT, INC., Lakewood, CO (US)

(21) Appl. No.: 11/769,579

(22) Filed: Jun. 27, 2007

Related U.S. Application Data
(60) Provisional application No. 60/821,983, filed on Aug. 10, 2006.

(51) Int. Cl. B01D 17/038

(52) U.S. Cl. 210/787; 210/805; 422/72

(57) ABSTRACT

A system and method for separating particles using an elutriation or low density fluid wherein a re-circulation line is provided to re-circulate the elutriation or low density fluid for re-use in the separation system and method.

### CROSS REFERENCE TO RELATED APPLICATIONS

This application claims the benefit of U.S. Provisional Application No. 60/821,983 filed Aug. 10, 2006.

### FIELD OF THE INVENTION

The present invention relates to a system and method for separating particles using an elutriation or low density fluid. The invention has particular advantages in connection with separating white blood cells into desired subsets.

This application is related to U.S. Published Application No. 2003-0116512. The entire disclosure of this U.S. publication is incorporated herein by reference to the extent it is not inconsistent.

### DESCRIPTION OF THE RELATED ART

Whole blood consists of a liquid component and particle components. Sometimes, the particle components are referred to as “formed elements”. The liquid portion of blood is made up of plasma, and the particle components primarily include red blood cells (erythrocytes) (RBCs), white blood cells (WBCs), and platelets (thrombocytes). While these particle constituents or components have similar densities, their average density relationship, in order of decreasing density, is as follows: red blood cells, white blood cells, platelets, and plasma. In addition, the particle constituents are related according to size, in order of decreasing size, as follows: white blood cells, red blood cells, and platelets. The sedimentation velocities of the particle constituents are related to their size and density.

In the medical field, for example for therapeutic applications, it is often desirable to separate blood into blood components and a liquid component, and to further separate the blood components into subsets. Most current separation devices rely on density and size differences or surface chemistry characteristics to separate and/or filter blood components for transfusion or reinfusion purposes. Typically, blood components are separated or harvested from other blood components using a centrifuge. The centrifuge rotates a blood reservoir to separate the components within the reservoir using centrifugal force. In centrifugal separation, blood typically enters a rapidly rotating separation reservoir or chamber and centrifugal force stratifies the blood components, so that particular components may be separately removed. Although some centrifugal separation techniques are effective at separating some blood components from one another, many centrifugal separation processes are not capable of producing a highly purified end product of a particular subset.

In one type of separation procedure, white blood cells are collected by leukapheresis. Such collection typically uses a centrifuge as described above. The resulting harvested or separated white blood cells can then be further separated into subsets of desired cells for collection or culture if desired. Such subsets of cells desired for collection may include monocytes, lymphocytes, and granulocytes, although it is understood that collection of other cells may also be desired. The collected leukapheresis products, however, are often contaminated with platelets and red blood cells which can interfere with various cell separation and/or cell selection techniques and later cultivation of the selected cells for therapeutic use. Thus it is desirable to separate the white blood cells into the desired subsets and remove or reduce the number of platelets and red blood cells.

Several methods have been proposed for the separation or fractionation of white blood cells from other particles and into more purified selected subsets. One such method is centrifugal elutriation. In one common form of elutriation, a cell batch is introduced into a generally funnel-shaped separation chamber located on a spinning centrifuge. A flow of liquid elutriation buffer or low density liquid is then introduced into the chamber containing the cell batch. As the flow rate of the liquid elutriation buffer solution is increased through the chamber (usually in a stepwise manner), the liquid sweeps smaller sized, slower-sedimenting cells toward an elutriation boundary within the chamber, while larger, faster-sedimenting cells migrate to an area of the chamber where the centrifugal force and the sedimentation (drag) forces are balanced.

Relatively long elutriation times may be needed to achieve optimum separation and purification of the selected cells into subsets of interest. Such long time periods require a continuous flow of the liquid elutriation buffer into the chamber. This in turn may require a larger volume bag and/or multiple smaller bags to hold the amount of liquid or buffer needed for optimal cell separation. Also the use of larger volumes of elutriation buffer add additional expense to each separation process.

Larger volumes of elutriation buffer can become inconvenient for the user as larger volume bags may be heavy and cumbersome, and depending on the size and weight of the bag, can possibly unbalance the machine.

Similarly, the use of multiple smaller bags may become costly as the user would have to purchase more bags to accommodate the higher volume needed as well as pay associate disposal costs for the buffer and waste bags. It may also be inconvenient to the user who would have to constantly replace the bags during the procedure.

It is against this background that the instant invention was conceived.

### SUMMARY OF THE INVENTION

It is one aspect of this invention to provide methods and apparatus to re-circulate the same liquid buffer through an elutriation system for re-use.

In another aspect, the invention includes an apparatus having a pre-connected re-circulation line connected to the outlet line of the elutriation chamber and a concentrator connected to the elutriation chamber. The recirculation line thus forms part of the disposable tubing set used for centrifugal elutriation separation.

### BRIEF DESCRIPTION OF THE DRAWINGS

The accompanying drawings are included to provide a further understanding of the invention and are incorporated in and constitute a part of this specification. The drawings illustrate an embodiment of the invention and, together with the description, serve to explain the principles of the invention. In the drawings,

FIG. 1 is a schematic diagram of a particle separation system in accordance with an embodiment of the invention;

FIG. 2 is a perspective view of a fluid chamber and separation vessel mounted on a centrifuge rotor as depicted in FIGS. 1, 3 and 4; and

FIG. 3 is a schematic diagram of a particle separation system in accordance with another embodiment of the invention.

FIG. 4 is a schematic diagram of a particle separation system in accordance with a still further embodiment of the invention.

### DESCRIPTION OF THE PREFERRED EMBODIMENT

Reference will now be made in detail to the embodiments of the invention, examples of which are illustrated in the accompanying drawings. Wherever possible, the same reference numbers are used in the drawings and the description to refer to the same or like parts.

The embodiment of the present invention includes an Elutra® blood component centrifuge manufactured by Gambro BCT, Inc. of Lakewood, Colo. The Elutra® centrifuge incorporates a one-omega/two-omega sealless tubing connection as disclosed in U.S. Pat. No. 4,425,112 to Ito, the entire disclosure of which is incorporated herein by reference. Although the embodiments of the invention are described in combination with the Elutra® centrifuge, this reference is made for exemplary purposes only and is not intended to limit the invention in any sense. It is understood that other centrifuges could be used with the embodiments of the instant invention, including, but not limited to, the COBE® Spectra apheresis system, the Trima® system and the Trima Accel® system, also manufactured by Gambro BCT Inc., as well as other elutriation devices used to separate blood components.

Similarly, the present invention may be advantageously used in a variety of centrifuge devices including, but not limited to, those commonly used to separate blood into its components. In particular, the present invention may be used with any centrifugal apparatus regardless of whether or not the apparatus employs a one-omega/two-omega seal-less tubing connection.

It will also be apparent that the teachings of the present invention can also be used for separating particles and blood cells as well as other cells. The description refers to both particles and cells and it is understood that both are used interchangeably without departing from the spirit of the invention. The teachings of the present invention further can be used with any elutriation system for separating particles and blood cells as well as other cells.

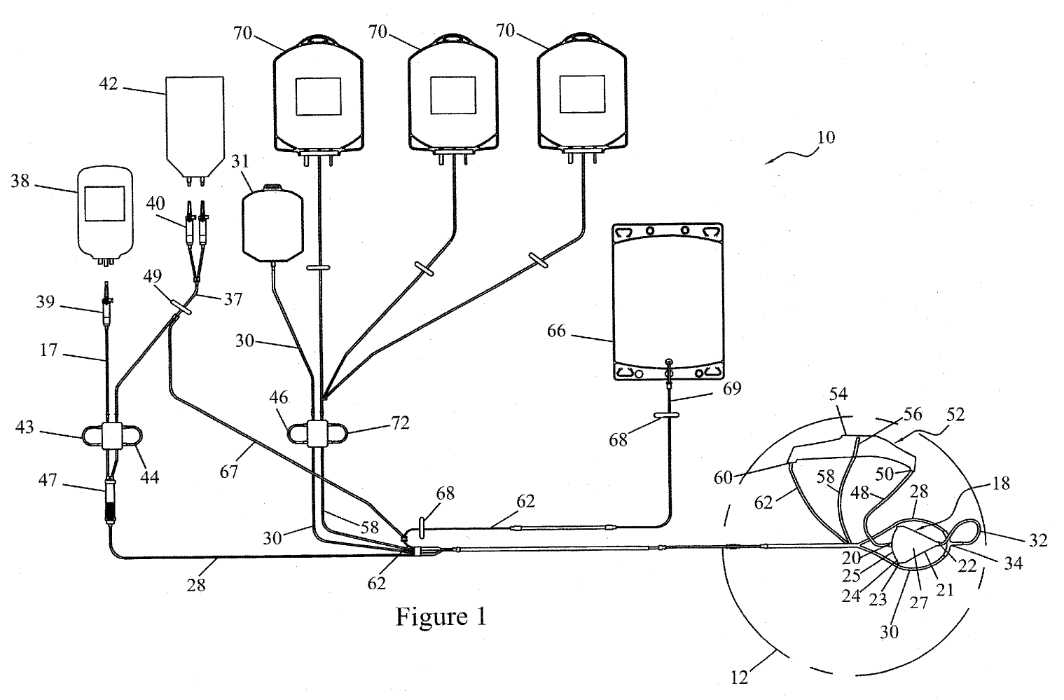

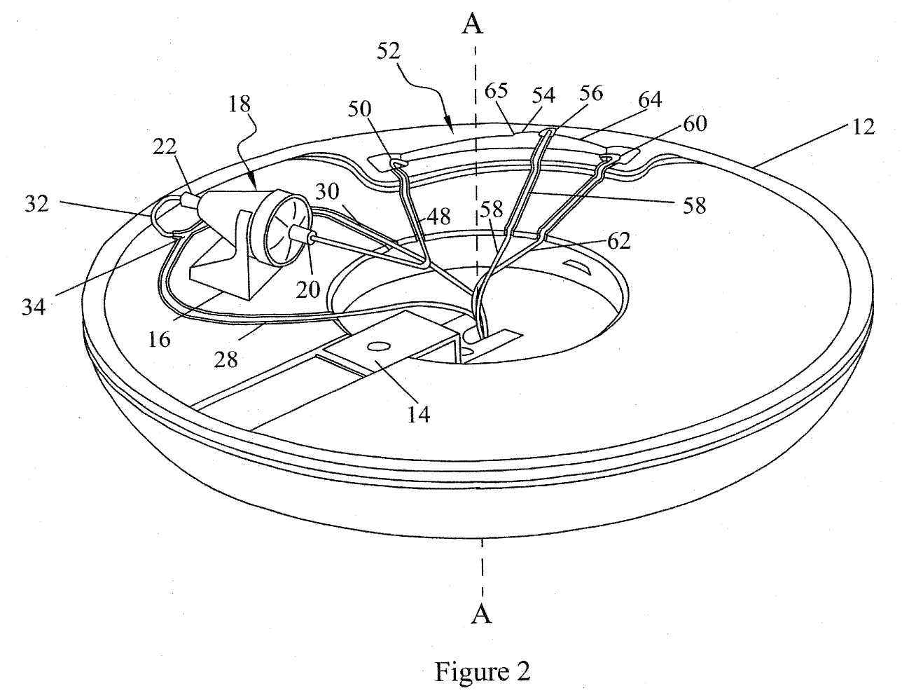

As embodied herein and illustrated in FIG. 1, the present invention includes a particle separation disposable system 10 for use with a centrifuge rotor 12. Preferably, the centrifuge rotor 12 is coupled to a motor (not shown) via an arm 14, shown in FIG. 2, so that the centrifuge rotor 12 rotates about its axis of rotation A-A.

As shown in FIG. 2, a holder 16 is provided on a top surface of the rotor 12. The holder 16 releasably holds a fluid chamber 18 on the rotor 12 such that an outlet 20 for components other than red blood cells, hereinafter called the outlet of the fluid chamber 18, is positioned closer to the axis of rotation A-A than the inlet 22 of the fluid chamber 18. The holder 16 preferably orients the fluid chamber 18 on the rotor 12 with a longitudinal axis of the fluid chamber 18 in a plane transverse to the rotor's axis of rotation A-A. In addition, the holder 16 is preferably arranged to hold the fluid chamber 18 on the rotor 12 with the fluid chamber outlet 20 for components other than red blood cells facing the axis of rotation A-A. Although the holder 16 retains the fluid chamber 18 on a top surface of the rotor 12, the fluid chamber 18 may also be secured to the rotor 12 at alternate locations, such as beneath the top surface of the rotor 12. It is also understood that the fluid chamber 18 could be secured by other well known fixative devices or by other methods other than the holder as shown.

The fluid chamber 18 may be constructed similar to or identical to one of the fluid chambers disclosed in U.S. Pat. No. 5,674,173 referred to above, although in the illustrated embodiment the fluid chamber may have smooth sides as shown in the Figures and described below. As shown in FIGS. 1, 2, 3 and 4, the inlet 22 and outlet 20 of the fluid chamber 18 are arranged along a longitudinal axis of the fluid chamber 18. A wall 21 of the fluid chamber 18 extends between the inlet 22 and outlet 20 thereby defining inlet 22, the outlet 20, the side and an interior of the fluid chamber 18.

The fluid chamber 18 includes two frustoconical shaped sections 25, 27 joined together at a maximum cross-sectional area 23 of the fluid chamber 18. The interior of the fluid chamber 18 tapers (decreases in cross-section) from the maximum cross-sectional area 23 in opposite directions toward the inlet 22 and the outlet 20. Although the fluid chamber 18 is depicted with two sections (25, 27) having frustoconical interior shapes, the interior of each section may be paraboloidal, or of any other shape having a major cross-sectional area greater than the inlet or outlet area.

The fluid chamber 18 may be constructed from a unitary piece of plastic or from separate pieces joined together using known fixative or sealing methods to form separate sections of the fluid chamber 18. The fluid chamber 18 may be formed of a transparent or translucent co-polyester plastic, such as PETG, to allow viewing of the contents within the chamber interior with the aid of an optional strobe (not shown) during a separation or debulking procedure.

As shown in FIGS. 1, 3 and 4 the system 10 which depicts a disposable further includes a first conduit or line 28, second or debulk conduit or line 30, an inlet conduit or line 32 in fluid communication with the inlet 22 of the fluid chamber 18, and a three-way or Y connector 34 having three legs for flow or fluidly connecting the first conduit 28, second or debulk conduit 30, and inlet line 32. The first conduit 28 includes peristaltic pump loop 43 for flow-connecting the first conduit 28 with conduit or line 17, coupling 39 and a first source 38 containing fluid carrying particles to be separated from one another or the source blood product containing white blood cells. Likewise, the first conduit 28 is connected through pump loop 44 to conduit or line 37 which includes couplings 40 for flow-connecting the first conduit 28 with a second source 42 containing a low density diluting, sedimentation or elutriation fluid. The couplings 39 and 40 are preferably any type of common medical coupling devices, such as spikes or sterile tubing connectors. It is understood that lines or conduits 17 and 37 may be connected through a coupling (not shown) upstream of the inlet peristaltic pump loop so that a single loop pump (not shown) can be used.

As shown in FIGS. 1, 3 and 4 and as described above the first conduit 28 includes tubing loops 43 and 44. During use, the tubing loops 43 and 44 are mounted in a peristaltic pump (not shown) for respectively pumping the fluid or cell or particle product to be separated and the diluting, sedimentation or elutriation fluid from the first and second sources 38 and 42, respectively.

The fluid and particles from the first source 38 and the diluting, sedimentation or elutriation fluid from the second source 42 flow through the respective first conduit 28 to the three-way connector 34. These substances then flow through the inlet line 32 into the inlet 22 of the fluid chamber 18. In the fluid chamber 18, which turns with rotor 12 when mounted thereon, the particles in the centrifugal field separate according to differences in sedimentation velocity leaving faster sedimenting particles in the fluid chamber 18 and allowing some slower sedimenting particles to flow from the fluid chamber 18 as will be described below.

As the fluid chamber 18 is loaded with particles as is more fully described below, the fluid and particles having a relatively slower sedimentation velocity, which generally includes plasma, platelets, and possibly some white blood cells, flow through the fluid chamber outlet 20 into conduit tubing or line 48. As shown in FIGS. 1, 2, 3 and 4 the tubing 48 is connected to an inlet 50 of separation vessel 52 or particle concentrator mounted on the centrifuge rotor 12. As described below, the separation vessel 52 or concentrator concentrates particles from fluid. Also during any elutriation process to separate the white blood cells into subsets such separated subsets will flow from the fluid chamber 18 to the separation vessel 52 or concentrator as more fully described below.

Adjacent to an outer portion of the centrifuge rotor 12, the separation vessel 52 or concentrator has a collection well 54 for collecting particles flowing into the separation vessel 52 or concentrator. Rotation of centrifuge rotor 12 sediments particles into the collection well 54 while slower sedimenting fluid and possibly some slower sedimenting particles remain above a top boundary of the collection well 54. The collected particles in the collection well 54 can include any cells or particles that have exited the fluid chamber 18, including a separated subset of white blood cells, as noted above.

The collection well 54 has a particle concentrate outlet 56 connected to a particle concentrate line or conduit 58. The particle concentrate line 58 removes particles retained in the collection well 54 along with a small portion of fluid as is more fully described below. The separation vessel 52 also includes a fluid outlet 60 connected to a fluid outlet line or conduit 62. The fluid outlet line 62 removes fluid flowing above a top boundary of the collection well 54. This fluid may include plasma or elutriation buffer or low density fluid. In addition, the fluid outlet line 62 may remove some slower sedimenting particles flowing above the top boundary layer past the collection well 54.

Preferably, fluid outlet 60 is located at or adjacent to one end of the separation vessel 52 or concentrator, and the inlet 50 is located at or adjacent to an opposite end of the separation vessel 52 or concentrator. This spacing ensures ample time for separation of particles from fluid, collection of a substantial number of particles in the collection well 54, and corresponding removal of a substantial number of particles including any separated subsets of white blood cells through the particle concentrate line 58.

In the embodiment shown in FIG. 2, the separation vessel 52 or concentrator is placed in a groove 64 formed in the rotor 12. Preferably, the separation vessel 52 or concentrator is a channel formed of a semi-rigid material so that a valley 65 in an outer wall of the groove 64 forms the collection well 54 when the separation vessel 52 or concentrator expands in response to fluid and particles in the separation vessel 52 or concentrator encountering centrifugal forces. As shown in FIG. 2, the top surface of the rotor 12 preferably includes retainer grooves for receiving the first and second conduits 28 and 30, three-way connector 34, tubing 48, particle concentrate line 58, and fluid outlet line 62.

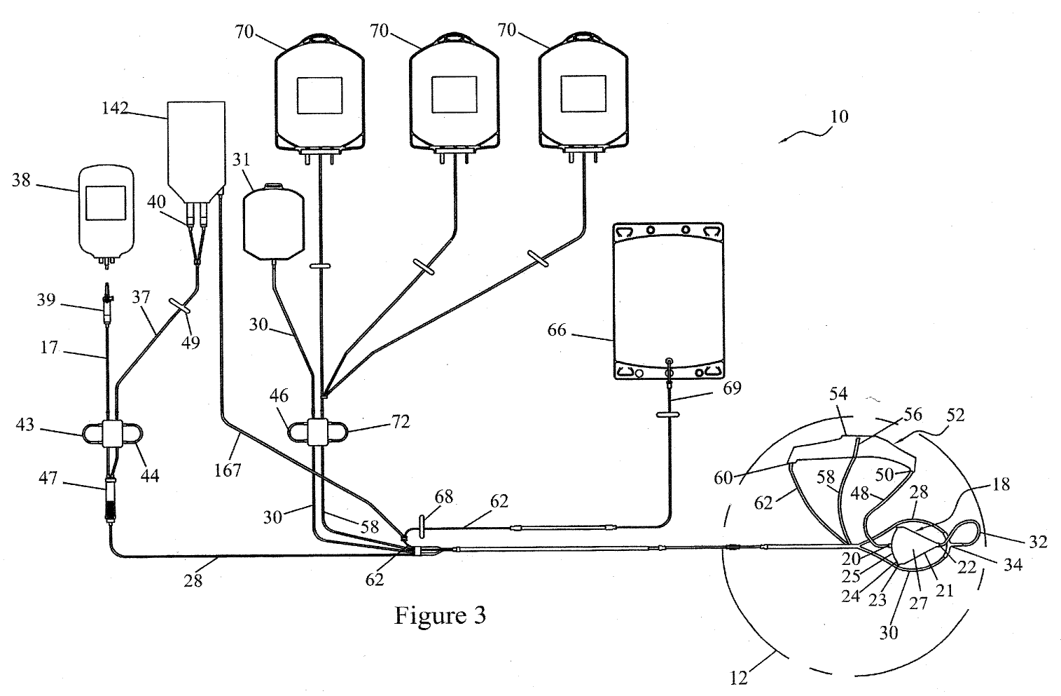

As shown in FIGS. 1, 3 and 4 the fluid outlet line 62 is fluidly coupled to a fluid collection container 66 for optionally collecting part of the fluid removed from the separation vessel 52 or concentrator, and the particle concentrate line 58 is fluidly coupled to one or more particle collection containers 70 for collecting particles removed from the separation vessel 52 or concentrator. Preferably, as shown in FIGS. 1 and 3 the particle concentrate line 58 includes a tubing loop or outlet pump loop 72 capable of being mounted in a peristaltic pump for pumping particles through the particle concentrate line 58. The pump for tubing loop 72 regulates the flow rate and concentration of particles in particle concentrate line 58. The white blood cells of interest or desired particles will be collected into one of the bags 70. It is understood that any number of bags 70 can be used to collect the desired subsets of white blood cells.

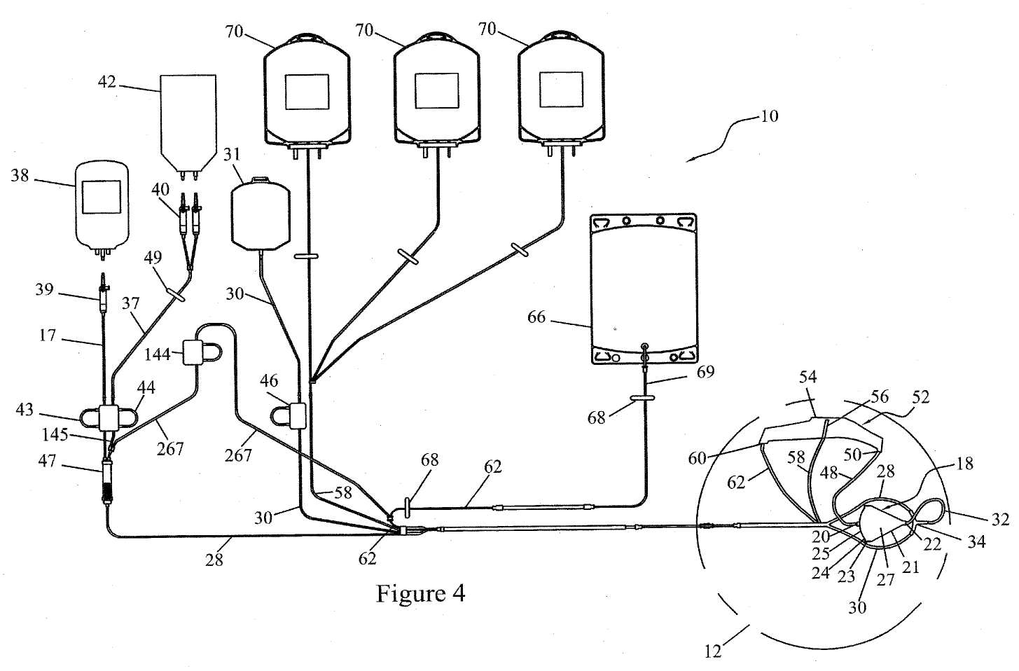

Also as shown in FIG. 4 the particles of interest can free flow into bags 70 under the control of the inlet pumps 43 and 44.

FIGS. 1, 3, and 4 as will be more fully described below, illustrate three collection bags for the blood cells of interest. Platelets can also be collected in a separate bag if desired.

After sedimentation in chamber 18, as shown in FIGS. 1, 3 and 4, red blood cells can be removed if desired through inlet 22 to inlet conduit 32. The debulked red blood cells then pass through Y connector 34 to debulking conduit 30. As shown in FIG. 1, conduit 30 is fluidly coupled to a red blood cell collection container or debulked cell collection container 31 for collecting red blood cells collected during the debulking procedure. Preferably the red blood cell collection or debulk line or conduit 30 includes a tubing loop 46 capable of being mounted in a peristaltic pump for controlling the flow of red blood cells through conduit 30 and out through inlet 22.

To control the flow rates of the various substances and cells and the rotational speed of the rotor 12 during operation of the system 10, a controller is provided. The controller (not shown) controls pumps (not shown) for pumping substances through the tubing loops 43, 44, 46 and 72 and controls a motor (not shown) for rotating the centrifuge rotor 12.

In FIGS. 1, 3 and 4 fluid and particles from the first source 38 are connectable by conduit 17 and tubing loop 43 associated with a peristaltic pump to air chamber 47. Also diluting, sedimentation or elutriation fluids from source 42 are connectable by conduit 37 and tubing loop 44 associated with a peristaltic pump to air chamber 47. Air chamber 47 provides an inlet filter for filtering aggregates prior to particle separation. Also the air chamber 47 acts as a bubble trap and an air detection chamber. The air chamber 47 further functions as a fluid pulse suppressor. Use of air chamber 47 is optional, however, and it is also understood that it can be omitted from the source delivery configuration.

In FIG. 1 a recirculation line or conduit 67 is connected from line or conduit 62 to fluid inlet line or conduit 37. A slide clamp or other flow controlling element 49 is on conduit 37 and a slide clamp or other flow controlling element 68 is on line 62. In the alternative embodiment of FIG. 3 a recirculation line 167 is connected from line or conduit 62 to media, diluting, sedimentation or elutriation fluid bag 142. A slide clamp 68 is shown on line 62. Bag 142 of FIG. 3 replaces bag 42 of the embodiment of FIG. 1.

In both the embodiments of FIG. 1 and FIG. 3 substantially cell free and plasma free media or fluid can be directed through lines 67 or 167 to upstream of inlet pump loop 44. This allows diluting buffer or media to be re-circulated and used as will be further described. The initial media or fluid from the concentrator 52 may contain plasma or cells undesirable for recirculation. This initial media or fluid is directed to waste bag 66, as described below, prior to initiation of the recirculation process.

In the further embodiment FIG. 4, recirculation line 267 is connected from line 62 to upstream of additional recirculation pump loop 144. In this embodiment re-circulated media or fluid can flow or be pumped through conduit or line 267 to conduit or line 145 and then through air chamber 47 to inlet conduit or line 28 to be re-used. This supplements the introduction of additional media from source 42.

A method of separating components of blood and, in particular, separating white blood cells from red blood cells is discussed below with reference to FIGS. 1, 2, 3 and 4. Although the invention is described in connection with a blood component separation process and specifically a white blood cell separation or fractionation process, it should be understood that the invention in its broadest sense is not so limited. The invention may be used to separate a number of different types of particles.

Initially, blood is collected from a patient and this blood is separated in a centrifugal separation process to isolate what is known as a blood product containing white blood cells. During this initial centrifugation process, platelet rich plasma and a portion of the red blood cells and more dense white blood cells may be separated from the blood, leaving the resulting white blood cell product. In addition, this resulting blood product most likely includes some platelets and red blood cells. Not all starting blood products will require an initial centrifugal separation. For example, collected blood from umbilical cords is generally not subject to an initial centrifugal separation. The starting blood product will then be provided from first source 38 in the apparatus described above.

The initial separation of the collected blood described above is preferably performed on a centrifuge (not shown) separate from the system 10, such as a dual stage or single stage centrifugal separator. In an alternative embodiment, the centrifuge rotor 12 may include structure for providing initial blood component separation on the centrifuge rotor 12, as disclosed in above-referenced U.S. Pat. No. 5,674,173. It is understood that the separated blood product could also be collected and initially separated if desired by other methods.

The resulting separated or collected blood product is placed in the first source 38 although the blood product could also come directly from a separation system through a conduit (not shown). The first source 38 is coupled to the first conduit 28 through conduit 17. In addition, the second source 42 (FIG. 1) or 142 (FIG. 3) containing the diluting, sedimentation or elutriation fluid is coupled to the conduit 28 through the conduit 37. The centrifuge rotor 12 is rotated about the axis of rotation A-A, at approximately 2400 rpm although other speeds can be used. The blood product is pumped from source 38 through pump loop 43 and loaded into the fluid chamber 18 at a flow rate selected to give the desired packing of the loaded product for the selected centrifuge speed. The pump associated with loop 43 is stopped to stop flow of blood product from source 38. Flow of diluting, sedimentation or elutriation fluid is then started using pump loop 44 and the action of it's associated pump to rinse conduit 28 and/or wash the loaded blood product. The diluting, sedimentation fluid or elutriation fluid passes through conduit 28 and Y connector 34, and inlet conduit 32 into the inlet 22 of chamber 18.

The inlet pump associated with the tubing loop 44 is stopped to stop the flow of low density diluting, sedimentation or elutriation fluid into the chamber 18. As the centrifuge continues to rotate the particle constituents loaded in the chamber sediment under the resulting centrifugal force.

After sedimentation of the particle constituents of the blood product, the pump associated with tubing loop 46 is activated to remove or debulk at a low flow rate the sedimented red blood cells R through the inlet 22 of the chamber 18 and then through inlet conduit 32 and debulking conduit 30 to container 31 if reduction of red blood cells is required.

After the reduction of fractionated red blood cells, the white blood cells remaining in chamber 18 can be further separated by elutriation, as described below, or the inlet pump associated with tubing loop 43 can be restarted to reintroduce a second batch of blood product from source 38 into chamber 18.

The elutriating step including introduction of diluting, sedimentation or elutriation fluid for separating white blood cells into the desired subsets can be done after each debulking procedure or after the source 38 is empty of blood product. The only requirement is that there be a sufficient number of white blood cells in chamber 18 to achieve effective separation or fractionation. Therefore, the white blood cell content of the starting blood product should be considered in determining the sequence order of the elutriation step.

For collection of fractionated or separated white blood cells or separated desired particles, an operator, after debulking or after the first source 38 is empty, slowly increases the inlet pump speed associated with tubing loop 44, decreases the centrifuge speed, or increases the density or viscosity of the diluting, sedimentation or elutriation fluid to separate the cells in chamber 18 into subsets by elutriation, as is well known in the art. With respect to the embodiments of FIGS. 1 and 3, the elutriation, sedimentation or diluting fluid used for separation initially flows into bag 66 as the initial flows of such fluid may contain plasma or starting cell suspension media. After clamp 68 is closed the more cell-free and substantially plasma free fluid flows through the recirculation line or conduit 67 or 167 in the case of FIG. 3, wherein it is pumped by loop 44 for re-use through optional chamber 47 conduit 28 and connector 34, inlet conduit 32 to the inlet 22 of chamber 18. The process then continues until the desired separation of cells in chamber 18 and the desired volume reduction of cells using concentrator 52 is achieved.

With respect to FIG. 4, the initial flow of fluid flows into bag 66 as described above. The more cell and plasma free fluid passes through line or conduit 267 where it is re-introduced by pump 144 into line or conduit 145 to inlet line or conduit 28. The process then continues under the described conditions and the separated cells then flow to bags 70.

The loading, adding of low density fluid, sedimenting, debulking and elutriating steps, described above are thus repeated until the entire blood product has been separated or fractionated into desired components or desired subsets and debulked of red blood cells.

At the end of the separation process slide clamp 68 or other well known operable connectors or clamps are opened and the remaining low density fluid passes into waste bag 66.

As noted above the cells loaded in chamber 18 can be elutriated or even washed by addition of a low density diluting, sedimentation, or elutriation fluid from source 42 having a sedimentation agent. It may be desirable that such low density fluid contain a protein such as Human Serum Albumin (HSA) or a fluid sedimentation agent such as Hydroxyethyl Starch (HAES).

It is understood that the protein and sedimentation agent specified above is only exemplary and that other well known proteins or sedimentation agents could be or could form the diluting, sedimentation fluid. It is also understood that the low density fluid could be media or plasma.

As the blood product is being loaded into the separation chamber 18, and during the elutriating step, the diluting, sedimentation or elutriation fluid, plasma, platelets, and the white blood cells and any other materials flowing from the fluid chamber outlet 20 pass through the intermediate tubing 48 to the inlet 50 of the separation vessel 52 or concentrator as noted above. In the separation vessel 52 or concentrator, centrifugal force caused by rotation of the rotor 12 retain the particles in the collection well 54, while the diluting fluid and plasma flow through the fluid outlet 60 and fluid outlet line 62 to container 66 or to recirculation lines 67, 167 or 267 (FIG. 4). This separates the platelets and other particles from the diluting fluid and plasma.

The particles and a portion of the fluids flow through the particle concentrate line 58 to one or more particle collection containers 70. As described above, any desired number of containers 70 can be used to collect the desired separated subsets of cells, including any separated subsets of white blood cells.

It is understood that other configurations could be used to re-circulate cell-free media or buffer, sedimentation fluid or diluting fluid. Such configurations include a separate media pump 144 as shown in FIG. 4 to bring the media from line 267 for entry into inlet line 28 below the primary inlet pump loop 44. Also as shown in FIG. 3, line 167 can directly enter media bag 42 for introduction into line 37 through 40.

In the present invention, only one bag of liquid buffer or diluting fluid may be needed if the buffer is re-circulated through the chamber along with any additional needed fluid from bag or source 42. This provides an advantage to the user as the amount of liquid buffer purchased would be decreased. The user would no longer need to buy larger or multiple bags of liquid. In addition, as the amount of liquid buffer introduced into the elutriation system decreases so does the amount of bag waste produced. This saves the user the additional cost incurred for destruction or disposal of the waste products. This makes the present invention with recirculation a less expensive alternative to existing systems. Re-circulating the liquid buffer could be cost effective, more convenient and could provide the user an easier way of operating the system. With re-circulation the user would no longer need to handle cumbersome heavier bags, replace multiple smaller bags or monitor the level of liquid in the bags. Only one bag would need to be used and the user would not need to replace or monitor the bag until optimum cell separation was achieved. This method provides an easier and more convenient way for the user to operate the elutriation system.

The total volume available for reuse can be calculated as follows:

V_{T} is the total amount of re-circulated fluid available for separation.

Vo is the initial volume of media or fluid in bag or source 42 after priming or other start up activities.

R is the percentage of the fluid re-circulated each flow cycle.

$${V}_{T} = \frac{100}{100 - R} = Vo$$

Example: Assume a starting media bag volume of 4 [symbol] Assume 500 m [symbol] is used to prime the system and to flush the system before recirculation is started.

Thus: Vo=3.51

[symbol]

If: 90% of the media is re-circulated then R=90

Giving: V_{T}=35

[symbol]

Thus an initial 4 [symbol] of media provided 500 m [symbol] for priming and an effective 35 [symbol] for elutriating, with a total waste of less than 4 [symbol] .

Although the diluting, sedimentation or elutriation fluid is added only at certain parts of the process, it is understood that other configurations are possible. For example, the fluid chamber 18 could be modified to include separate inlets for blood components and diluting or sedimentation fluid. The diluting or sedimentation fluid could also be added to the blood components in the first source 38 before, or at the beginning of, a batch separation process. This alternative arrangement can also be used with the recirculation line or conduit. That is, the line can be connected to the inlet of the fluid chamber or to the source bag 38.

It is anticipated that the fluid chamber 18 can be sized to contain any desired amount of product.

The disposable particle separation system may also optimally include sensors at various output locations such as in the particle concentrate line for monitoring the types of cells and concentration being collected. Any known type of a sensor could be used.

It will be apparent to those skilled in the art that various modifications and variations can be made to the structure and methodology of the present invention without departing from the scope or spirit of the invention. For example, the present invention could be used to separate tumor cells from red blood cells, and the cell suspension in the first source 38 may include T cells and/or stem cells. In view of the foregoing, it is intended that the present invention cover modifications and variations of this invention provided they fall within the scope of the following claims and their equivalents.

What is claimed:

1. A method of fractionating a blood product comprising:
loading a fluid chamber through its inlet with a blood product having at least first and second particles;
adding a low density fluid to the loaded blood product in the fluid chamber;
sedimenting the particles in the fluid chamber in accordance with their sedimentation velocities; and
re-circulating the low density fluid from the fluid chamber back to the inlet of the fluid chamber for use in the adding step.

2. The method of claim 1 further comprising:
removing at least one of the first or second particles having the greater sedimentation velocity through the inlet of the fluid chamber leaving the other of the first and second particles in the fluid chamber.

3. A method of claim 1 further comprising:
repeating the loading, adding, sedimenting, and re-circulating steps until all blood product has been fractionated.

4. The method of claim 1 further comprising:
removing one of the first and second particles from the fluid chamber; and
collecting one of the first and second particles.

5. The method of claim 4 further comprising:
concentrating one of the first and second particles prior to the collecting step.

6. The method of claim 1 wherein the re-circulating step comprises:
adding the re-circulated low density fluid to a source container for the low density fluid.

7. The method of claim 1 wherein the adding step comprises:
pumping low density fluid to the fluid chamber with a pump; and
the re-circulating step further comprises adding the re-circulated low density fluid fluidly above the pump prior to the pumping step.

8. The method of claim 1 wherein the re-circulating step further comprises:
pumping the re-circulated fluid to the inlet of the fluid chamber.

9. The method of claim 1 further comprising:
flowing some of the low density fluid to a waste bag prior to the re-circulating step.

10. The method of claim 1 further comprising:
debulking one of the first and second particles through the inlet of the fluid chamber.

11. A system for separating first particles from second particles in a blood product comprising:
a source of blood product having at least first and second particles;
a low density fluid source;
a collection container;
a fluid chamber having an inlet and an outlet;
a first conduit fluidly connecting the blood product source and the low density fluid source to the inlet of the fluid chamber;
a second conduit fluidly connecting the outlet of the fluid chamber to the collection container for separated particles; and
a re-circulation conduit fluidly connecting the outlet of the fluid chamber to the first conduit for re-circulating low density fluid back to the inlet of the fluid chamber.

12. The system of claim 11 wherein the re-circulation conduit is connected to the low density fluid source to provide any re-circulated low density fluid to the first conduit.

13. The system of claim 11 wherein the re-circulation conduit is connected to the first conduit and the second conduit.

14. The system of claim 11 wherein the re-circulation conduit is connected to the first and second conduits and forms a re-circulation pump loop between the first and second conduits.

15. A system of claim 11 further comprising
a particle concentrate line fluidly connected to the outlet of the fluid chamber; and
fluidly connected to the collection container.

16. The system of claim 15 further comprising:
a separation vessel fluidly connected to the particle concentrate line and the collection container to concentrate the particles for collection.

17. A disposable particle separation system comprising:
a first coupling adapted to be connected to a source of particles to be separated;
a second coupling adapted to be connected to a source of low density fluid;
a first conduit fluidly connected to the first and second couplings;
a fluid chamber fluidly connected to the first conduit wherein the fluid chamber further comprises
an inlet;
an outlet
a collection container;
a second conduit fluidly coupled to the fluid chamber outlet and the collection container;
a re-circulation line fluidly coupled to the second conduit and the first conduit.

18. The disposable particle separation system of claim 17 wherein the fluid chamber further comprises:
a wall having a smooth interior surface extending between the inlet and outlet;
a maximum cross-sectional area in the wall wherein the wall tapers from the maximum cross sectional area to the inlet and from the maximum cross-sectional area to the outlet; and
the disposable particle separation system further comprises a particle concentrator fluidly connected to the outlet of the fluid chamber and to the second conduit.

19. The disposable particle separation system of claim 17 further comprising:
a debulking conduit for receiving particles fluidly connected to the inlet of the fluid chamber.

20. The disposable particle separation system of claim 19 further comprising:
a three-way connector for fluidly connecting the first conduit to the inlet of the fluid chamber and for fluidly connecting the debulking conduit to the inlet of the fluid chamber.

21. The disposable particle separation system of claim 20 further comprising an inlet conduit connected to the inlet of the fluid chamber and to the three-way connector.

22. The disposable particle separation system of claim 19 further comprising a debulking collection container fluidly connected to the debulking conduit.

23. The disposable particle separation system of claim 17 wherein the particles to be separated include white blood cells to be separated into white blood cell subsets.

24. The disposable particle separation system of claim 19 wherein the particles received by the debulking conduit include red blood cells.

25. A method of separating a white blood cell product having white blood cells and red blood cells into white blood cell subsets comprising:
loading a fluid chamber through its inlet with the white blood cell product;
adding a low density fluid to the white blood cell product;
sedimenting the white blood cells and the red blood cells in the white blood cell product in the fluid chamber;
re-circulating a portion of the low density fluid added to the white blood cell product to be used in the adding step; and
collecting the white blood cells.

26. The method of claim 25 further comprising
separating by elutriation the white blood cells into white blood subsets prior to the collecting step.

27. The method of claim 26 further comprising:
removing the separated white blood cell subsets through the outlet of the fluid chamber;
providing the removed separated white blood cell subsets to a particle concentrator;
separating in the particle concentrator fluid from the white blood cell subsets prior to the collecting step.

28. A method of claim 25 further comprising:
removing the sedimented red blood cells through the inlet of the fluid chamber.
